(19) United States
(12) Patent Application Publication
(10) Pub. No.: US 2021/0089784 A1
(43) Pub. Date: Mar. 25, 2021

(54) System and Method for Processing Video Data from Archive

(71) Applicant: OOO ITV Group, Moscow (RU)

(72) Inventors: Maksim Yusupovich Rasulov, Krasnodar (RU); Igor Igorevich Falomkin, Moscow (RU)

(21) Appl. No.: 16/938,711

(22) Filed: Jul. 24, 2020

(30) Foreign Application Priority Data
Sep. 20, 2019 (RU) 2019129646

(51) Int. Cl. G06K 9/00; H04N 5/247; G06F 3/0482; G06F 3/0484; H04N 5/765; G06K 9/62; H04N 7/18; G06T 7/20; G06F 16/71; G06F 16/738; G06F 16/735; G06F 16/787; G06F 16/783

(52) U.S. Cl. CPC G06K 9/00744; G06T 2207/10016; G06F 3/0482; G06F 3/04847; H04N 5/765; G06K 9/00288; G06K 9/00758; G06K 9/00362; G06K 9/6215; H04N 7/181; G06K 9/00771; G06T 7/20; G06F 16/71; G06F 16/738; G06F 16/735; G06F 16/787; G06F 16/784; G06K 2209/27; G06K 2209/15; G06K 2209/23; G06T 2207/30241; G06T 2207/30196; G06T 2207/30252; G06T 2207/30232; H04N 5/247

(57) ABSTRACT

The invention pertains to the field of video data analysis and processing, and more specifically to technologies aimed at finding information about objects of interest by the minimum known initial data. The system for processing the data from the archive comprises video cameras, memory, a database, a data processing device, and a graphical user interface. The graphical user interface comprises a video camera selection unit, a time period setting unit, a search mode selection unit, a search features unit, and a display. The data processing device is configured with the ability to perform the video data decompression and analysis, process the archive video data, perform the search, and display the search results through the display. The method for processing the data from the archive comprises providing a choice of specific video cameras of the system, setting a specific video time period, providing a choice of search mode from the search modes, setting the known object features, processing the archive video data, and searching for the corresponding metadata, wherein the metadata is generated by video data decompression and analysis and stored in the system database.

### RELATED APPLICATIONS

This application claims priority to Russian Patent Application No. RU 2019129646, filed Sep. 20, 2019, which is incorporated herein by reference in its entirety.

### FIELD OF THE INVENTION

The invention pertains to video data analysis and processing, and more specifically to technologies aimed at finding information about objects of interest using minimally known initial data.

### BACKGROUND

Video surveillance systems generally are hardware, software and/or technical devices that use computer vision methods for automated data collection based on video data analysis. Video surveillance systems (VSS) are based on image processing and pattern recognition algorithms that allow running video analysis without direct involvement of a person. The data obtained as a result of analysis and processing are further used to search for objects of interest.

Known video surveillance systems, depending on the specific purposes, can implement many functions, such as: detection of objects of interest, tracking object movement, tracking objects with multiple cameras, recognition and identification of objects, constructing object trajectories, etc.

Recently, methods of search by faces or vehicle license plates have gained great popularity. Various image recognition methods continue to be developed to improve their accuracy. However, such systems are absolutely useless for search purposes if a user does not have a photo of the person of interest or their car license plate. It is even more difficult to search if the user does not even know the full name of the person of interest.

Background provides a system disclosed in the US patent U.S. Pat. No. 9,208,226 B2, published Dec. 8, 2015, which describes a device for generating video including a video object indexing unit configured to recognize an object by storing and analyzing videos received from multiple surveillance cameras; a video object search unit configured to compare received search conditions with the object metadata, and then to output search results, including feature information of at least one object, which corresponds to the search conditions; video generation unit configured to generate video by aggregating only videos including a specific object selected from the search results; wherein the video editing unit configured to generate the evidence video by extracting sections, including the specific object, from the stored videos and then aggregating the sections; a video generation unit configured to generate data about the stored videos and the generated video, and then to store the generated video and the data in digital storage format; and a path analysis unit configured to acquire a path of the specific object among the multiple surveillance cameras by analyzing correlations between the search results.

This solution implements search of objects of interest with the specified search characteristics and further aggregation of the video of their paths. One difference of this solution from the disclosure consists in the search method itself, as well as in the lack of selection of specific video cameras and search mode.

Another known system which is relevant to the disclosure is disclosed in the US patent U.S. Pat. No. 9,615,064 B2, published Apr. 4, 2017, which describes the systems and methods for tracking an object using multiple cameras. The method includes steps such as: capturing, using a first camera, a first set of frames, wherein: the plurality of cameras comprises the first camera; the first set of frames comprises a first set of images of the object; and the first set of frames is captured from a first point of view; capturing, using a second camera, a second set of frames, wherein: the plurality of cameras comprises the second camera; the second set of frames comprises a second set of images of the object; and the second set of frames is captured from a second point of view; calibrating the first camera and the second camera using a calibration process based on physical locations known to be within a field of view of both the first camera and the second camera; determining, using the first camera, a presence of the object in the first set of frames; linking, by the first camera, metadata to the presence of the object, wherein the metadata indicates at least one characteristic of the first set of images of the object; transmitting the metadata from the first camera to a computing system; and identifying, by the computing system, based at least in part on the metadata received from the first camera, that the second set of images captured by the second camera represents the same object as the object in the first set of images in the first set of frames; and selecting, by the computing system, the first set of frames or the second set of frames for display to a user based on respective locations of the object in the first set of frames and the second set of frames relative to centers of fields of view of the first camera and the second camera, respectively.

This solution compares the objects to determine whether an object from two different cameras is the same object, but this solution is used to track a specific object with a specific set of characteristics for its further display.

One common difference between the known solutions and the disclosure is the lack of specific search mode selection. In the abovementioned known solutions, there is no search by faces or vehicle license plates, hence, the search technology itself is significantly different (aimed only at objects). In addition, the disclosure includes a user interface of the video surveillance system, which features units with specific functions for efficient operation of the system.

The disclosure addresses a reverse task compared to the solutions known from the background. That is, in the known background, the path of a given person/object is determined (for determination of their movement trajectory, or for tracking their movement in real time), while the disclosure addresses, on the contrary, determination of a specific person (or object/vehicle license plate) using a conjectured path of their movement and the time period.

### BRIEF SUMMARY

This technical solution is aimed to eliminating the disadvantages of the existing background and improving existing solutions.

The main objective of this technical solution is facilitating investigations of offenses with minimal initial data available. For example, when the user doesn't know the offender's name and have no photos of them (or license plates of their vehicle) but knows the cameras on which the offender may appear at a certain time.

The technical result of the claimed group of inventions is to increase the efficiency of searching for the object of interest with minimal initial data.

This technical result is achieved by the system for processing data from the archive comprising: at least two video cameras; memory configured for storing an archive video data coming from all video cameras of the system; a database for storing metadata; a graphical user interface (GPI) comprising: a video camera selection unit allowing the user to select specific cameras from which data are to be processed; a time period setting unit enabling the user to set a time period for the selected cameras; search mode selection unit enabling the user to select one of three modes: a face search mode, vehicle license plate number search mode, object search mode; a search features unit configured for setting the known features of the object to perform search in the object search mode, and a display configured for display of the search results; and the system contains at least one data processing unit configured to perform the following steps: decompression and analysis of video data to generate metadata that characterizes data on all objects in the video, wherein the mentioned metadata is recorded in the system database; archived video data processing and search by their respective metadata, after the user has selected the video cameras, set the time periods, and selected the search mode, to identify all persons or vehicle license plate numbers or objects found in the video data received from most of selected video cameras by comparing the data from different selected video cameras; display of the search result on the display.

This technical result is also achieved by the method for processing the data from the archive implemented by a computer system that includes at least one data processing device, database and memory storing the archive of video data received from all video cameras of the system, wherein the method contains the steps at which the following operations are performed: providing the user with a choice of video cameras of the system, the data from which will be processed; setting a video time period for the selected video cameras by the user; providing the user with a choice of search mode: face search mode, vehicle license plate number search mode, and object search mode; setting the known object features by the user to perform the search, if the object search mode is selected; processing archived video data and searching for their respective metadata, after the user has selected the video cameras, set the time periods, and selected the search mode, wherein metadata characterizing the data on all objects in the video are generated by decompression and analysis of video data and stored in the system database; identification of all faces or vehicle license plate numbers found in the video data received from most of the selected video cameras by comparing the data from different selected cameras; displaying the search result.

In one example embodiment of the solution, the metadata generation stage is performed either during the system operation, when video data is received in real time from video surveillance cameras, or immediately before the search, after the user has selected the video cameras, set the time periods, and selected the search mode.

In another example embodiment of the solution, in the face search mode, all faces recognized in the video data from different selected video cameras are compared to identify all cases when the same face was recognized in the video data from the largest number of the selected video cameras.

In another example embodiment of the solution, in the vehicle license plate number search mode, all vehicle license plate numbers recognized in the video data from different selected video cameras are compared to identify all cases when the same vehicle license plate number has been recognized in the video data from the largest number of the video cameras selected.

In another example embodiment of the solution, the following operations are performed in the object search mode: search for all objects meeting the set object features and comparison of all objects found in the video data from different selected video cameras to identify all objects in the video data received from the largest number of the video cameras selected.

In another example embodiment of the solution, the object features include the following: object type, object color, minimum object size, maximum object size.

In another example embodiment of the solution, the object types include: a person, a group of people, a vehicle, or an abandoned object.

In another example embodiment of the solution, the time period setting unit is configured to enable the user to set the video time period for each selected camera.

In another example embodiment of the solution, the GUI additionally contains a minimum camera share setting unit enabling the user to set the share of selected cameras, in the video data from which the searched face or vehicle license plate number or object must be present in order to be included to the search results.

In another example embodiment of the solution, the camera selection unit is additionally configured to enable the user to set, for each selected video camera, the minimum number of appearances of the searched face or vehicle license plate number or object in the camera view area.

In another example embodiment of the solution, the GUI additionally contains the unit for building the logic chains, enabling the user to set the video cameras sequence corresponding to a supposed motion path of the searched person or a vehicle or an object.

In another example embodiment of the solution, at comparison of all detected objects, each object found in the video data from the first video camera is compared with each object from each subsequent chosen video camera.

In another example embodiment of the solution, the objects detected are compared by the visual similarity calculated using a neural network.

In another example embodiment of the solution, the GUI additionally contains a similarity percentage setting unit enabling the user to set a minimum percentage of similarity of the faces when comparing the faces in the face search mode and a minimum percentage of similarity of vehicle license plate numbers when comparing them in the vehicle license plate number search mode, wherein, if the resulting similarity percentage exceeds the set minimum percentage, the system will consider that the faces or vehicle license plate numbers are similar to a sufficient degree and show them in the search results, and if this percentage is smaller they will be filtered out.

In another example embodiment of the solution, the search result is further compared with the database to identify the person or owner of the found vehicle.

In another example embodiment of the solution, the search result is displayed as a list or a set of frames.

This technical result is also achieved by a computer-readable data carrier which contains instructions, executed by the computer's processor, for the implementation of methods for processing of data from the archive.

### BRIEF DESCRIPTION OF THE SEVERAL VIEWS OF THE DRAWINGS

FIG. 1 is a block diagram of the system for processing data from the archive.

FIG. 2 is a block diagram of one of the embodiments of the method for processing data from the archive.

### DETAILED DESCRIPTION

Description of example embodiments of the claimed group of inventions is presented below. However, the claimed group of inventions is not limited only to these embodiments. It will be obvious to persons who are experienced in this field that other embodiments may fall within the scope of the claimed group of inventions described in the claim.

The claimed technical solution can be implemented in the form of computer systems and methods for processing the data from the archive, as well as in the form of a computer-readable data carrier.

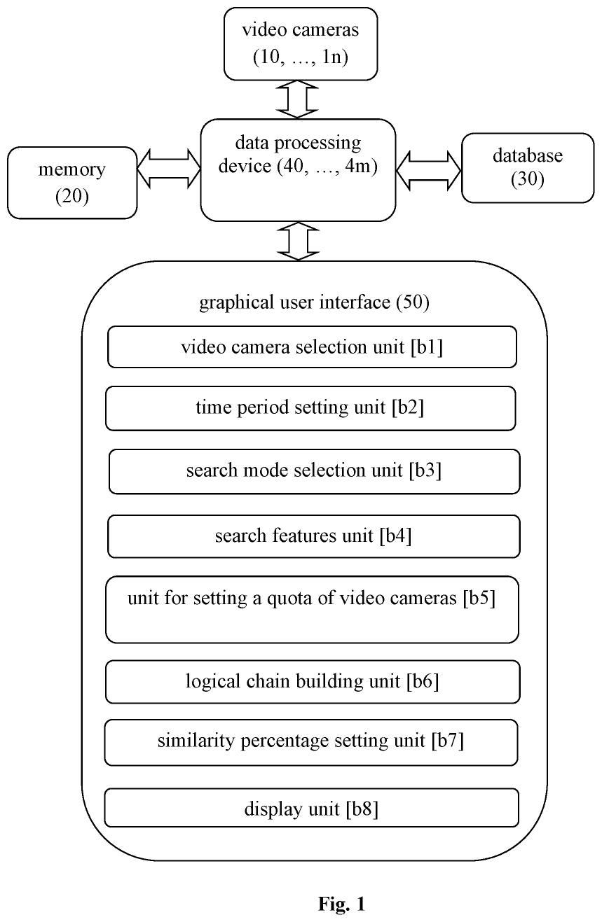

FIG. 1 shows a block diagram of one implementation of a computer system for processing the data from the archive. This system includes: at least two video cameras (10, . . . , 1n); memory (20); database (30); at least one data processing device (40, . . . , 4m); and graphical user interface (50) containing: video camera selection unit [b1], time period setting unit [b2], search mode selection unit [b3], search characteristics unit [b4], camera quota setting unit [b5], logical chain unit [b6], similarity percentage setting unit [b7], and display [b8].

To further understand the essence of the solution, it should be explained that the graphical user interface (GUI) is a system of tools for user interaction with the computing device based on displaying system objects and functions available to the user in the form of graphical screen components (windows, icons, menus, buttons, lists, etc.). The user has a random access via data input/output devices to all visible screen objects—interface units—which are displayed on the display/screen.

The GUI of the claimed system does not need to contain all the aforementioned units. Also, the GUI may include any other units not described above, in addition to or instead of the specified ones, depending on circumstances and user requirements in each particular video surveillance system.

The data input/output device can be, but is not limited to, mouse, keyboard, touchpad, stylus, joystick, trackpad, etc.

Computer systems are any hardware- and software-based systems, such as: personal computers, smartphones, laptops, tablets, etc.

Memory devices may include, but are not limited to, hard disk drives (HDDs), flash memory, ROMs (read-only memory), solid state drives (SSDs), etc. In order to further understand the essence of the solution, it should be explained that the system memory stores an archive of video data coming in real time from all video cameras of the system.

The database is a set of data systematized in such a way that these data can be found and processed using the data processing device. In the context of this disclosure, at least three databases are discussed. The first database is a part of the system and is configured to systematically store the metadata obtained from the analyzed video data from video surveillance cameras. The second database contains information about people (e.g., people who have already been prosecuted for offences or who have been added to the database for some other reason) that can be used to identify the person. The third database is a car license plate database, which stores information about vehicle owners.

The data processing device may be a processor, microprocessor, computer, PLC (programmable logic controller) or integrated circuit configured to execute certain commands (instructions, programs) for data processing. The processor can be multi-core for parallel data processing.

This system may include any other devices known in the field of disclosure, such as graphics cards (including GPUs), various sensors, etc.

An example of the aforementioned system for processing the data from the archive will be described in detail below.

At present, it is difficult to imagine a commercial building (shop, bank, etc.) without video surveillance cameras. In addition, residential buildings are being equipped with more and more video cameras as well. There are cameras on the streets, in parks and alleys, in houses (entrances and floors), etc. An example is a street video surveillance system of a large residential area, which has video surveillance cameras all over its territory. It should be noted that a protected zone of absolutely any area can be considered.

Suppose an offence, such as a store break in, has occurred in the area in question. The intruder was wearing a mask, so no one could see his face. The police officer interviewed all the witnesses and formed a set of burglar's features, such as: he was a man, he had black pants and a gray jacket on, he was wearing a mask. In addition, based on the testimonies of the people interviewed from nearby buildings, there are several places where a similar person was seen, as well as an approximate time when he was seen. However, there is neither a photo nor the name of the offender. This would seem to be a difficult task prior to the invention, and the criminal might have never been found. The solution is intended to facilitate investigations of this or similar types of offences.

First, the system operator specifies all known data about the offender. For this purpose, the graphical user interface of the claimed system is equipped with the necessary data input and output devices.

By using the video camera selection unit [b1], the user specifies/selects video cameras with the field of view where the offender could appear. In addition, the camera selection unit [b1] is configured to enable the user to set, for each selected video camera, the minimum number of appearances of the searched face (or vehicle license plate number or object) in the camera view area. For example, if it is known that the offender entered the bank and then left it, it is logical to set “2” appearances of the searched person (or object) as the minimum number of appearances for the camera with the bank entrance in its field of view. In case of search by vehicle license plate numbers, this function is also useful. For example, if it is known that the vehicle was driven through the view area of camera A once and through the view area of camera B twice, it will be easier to identify the vehicle being searched for. The default setting for the minimum number of appearances is 1.

Next, the user sets a time period for the video in the time period setting unit [b2]. In this case, the general time period for all cameras, for example, for May 2, 2018 from 10:00 to 16:30 can be set (if a more specific time period is unknown). If there are witness testimonies, for example, that the suspect was at the store at 10:13, then was seen at the bank at about 10:50, then was seen in the yard at the building entrance between 11:30 and 12:15, whereupon he entered the building and left in the evening, then, for such a case, the time period setting unit is configured so that the user can set a separate video time period for each camera.

Then, the user selects one of three possible search modes using the search mode selection unit [b3]: face search mode, vehicle license plate number search mode, or object search mode. In the example with the masked offender, it is obvious that the system operator will choose the object search mode, since we have only a set of the offender features. However, if it is known that the offender took off the mask as soon as he left the scene of the crime, then the face search mode can be selected to identify the offender more quickly. If the time when the offender took off the mask is not known exactly, then it is better to choose the object search mode. Although the object search mode is more general, it can be more effective in some cases. Faces and numbers can be recognized incorrectly or not recognized at all, if, for example, the object is poorly visible due to its distance from the camera. Thus, it is much easier to recognize the signs such as the color of a jacket and pants. If the selected search mode does not provide positive results, the user can select another search mode or refine the entered data.

For the object search mode, the GUI provides a search features unit [b4], which enables the user to specify the known features of the object. The object features include: object type, object color, minimum object size, maximum object size. The object types include: a person, a group of people, a vehicle, or an abandoned object.

In the described solution, the search is made by metadata to accelerate the search. Metadata that characterizes all objects in the video may include:

a characteristic vector describing a person;

a license plate number of a vehicle (car, motorcycle, etc.);

a characteristic vector describing a person's appearance; or

any information enabling the object to be re-identified both within a single or multiple video camera and at different times.

Before starting the search, it is necessary to perform a preparatory stage: metadata generation. For this purpose, at least one data processing device performs video data decompression and analysis. The metadata obtained after the analysis is recorded in the system database. The metadata generation stage may be performed at different times in various embodiments of the invention: either in the process of system operation, when the video data is received in real time from surveillance cameras, or just before the search, after the user has selected the video cameras, set the time periods, and selected the search mode.

Once all the necessary data is provided and the metadata is generated, the system starts processing the archived video data and searches for the corresponding metadata. The search is performed after the user selects the video camera, sets the time periods, and selects the necessary search mode.

The search aim is to identify all persons or vehicle license plate numbers or objects detected in the video data received from the largest number of the selected cameras by comparing data from different cameras. This stage will be considered in more detail for each search mode.

In the object search mode, the system searches for all objects meeting the set object features. Next, all detected objects from different selected cameras are compared to find the same objects found in video data received from the largest number of selected cameras. For example, let's assume that the user has selected 10 cameras. Each selected camera has different objects in its field of view. After conducting a search according to the specified characteristics, the system filtered out most of the objects, because they do not meet the search criteria. The other objects are compared with each other in series. That is, each object detected in the video data from the first camera is compared with each object from the second camera and so on with each object of each subsequent selected camera. If the system detected that “object 1” appears in the field of view of three selected cameras and “object 2” appears in the field of view of eight cameras in the specified time periods, then the system would generate “object 2” as the search result, since 8 is greater than 3. In this example, 8 is the largest number of the selected cameras with field of view where the requested object was found. The found objects are compared by their visual similarity, which is calculated by a neural network.

In the face search mode, all faces recognized in the video data from the selected video cameras are compared to identify the cases when the same face is recognized in the video from the largest number of the selected video cameras. The system returns all cases where the same face has been recognized by the most (but not necessarily all) of the selected cameras in the time period set for each camera.

A similar process takes place in the vehicle license plate number search mode, in which all vehicle license plate numbers recognized in the video from the selected video cameras are compared to identify all cases where the same vehicle license plate number has been recognized in the video data from the largest number of the selected video cameras. The system searches for the vehicle with the same license plate number detected in the field of view of the majority of the selected cameras within the set period of time.

In some embodiments, the GUI further contains a unit for setting the similarity percentage [b7]. This unit enables the user to set the minimum similarity percentage of faces compared in the face search mode and the minimum similarity percentage of vehicle license plate numbers compared in the license plate number search mode. If the resulting similarity percentage exceeds the specified minimum percentage, the system assumes that the faces or the numbers are sufficiently similar and display them in the search results, and if this percentage is smaller, the system filters them out.

To increase the system accuracy and avoid erroneous results, the GUI can additionally contain a unit for setting the minimum quota of cameras [b5]. Using this unit, the user sets the quota of the selected cameras, the video data from which must contain the searched face (or vehicle license plate number, or object) for this data to be included in the search results. For example, if 10 cameras are selected, the user can set the minimum quota to 7, which means that if the object (face, number) appears in the field of view of at least seven cameras within the set period of time, it will be sufficient for this object to be included in the search results. If the object appears in the view area of seven or more cameras out of ten possible, this object will be displayed in the search results.

In addition, to enhance the search accuracy and the system performance as a whole, the GUI can additionally contain the unit for building the logic chains [b6]. This unit enables the user to set the sequence of video cameras corresponding to the supposed motion path of the searched person (or vehicle license plate number, or object). For example, if it is known for sure that first the object appeared in the camera 1 (near the subway exit), then in the camera 2 (entered the store), then passed by the camera 3, camera 4, or camera 5 (entered one of the entrances of a building; the exact entrance is unknown). The objects appearing in another sequence in the view areas of the selected cameras would not be included in the search results. In the above example, the user can also set the minimum quota of cameras to 3 out of the five selected cameras and set the minimum number of appearances to 2 for the camera 2 (since the object had entered and left the store).

The final stage of the system's operation is outputting the search results using the GUI display [b8]. The search results are displayed either as a set of frames which show the objects (or faces or numbers) or as a list. When the results are displayed as a list, the user can click on the line of each result to display the information about the found object (or face, or vehicle license plate number).

In the face search mode and the vehicle license plate number search mode, the search results can be compared with the database after the system operation is completed. For example, if the search result is a video frame with the searched person in it, this image can be compared with a database of people to identify the detected person and obtain the available data about them. Similarly, if the search result is a vehicle license plate number, this number can also be compared to a database of vehicle license plate numbers to identify the vehicle's owner.

As can be seen, by performing a search using the claimed system in its various embodiments, it is possible to make significant progress in the investigation and identify the offender within the shortest possible time. Moreover, it should be noted that the system provides high speed and accuracy of search even given the minimum initial data available, i.e., an increased efficiency.

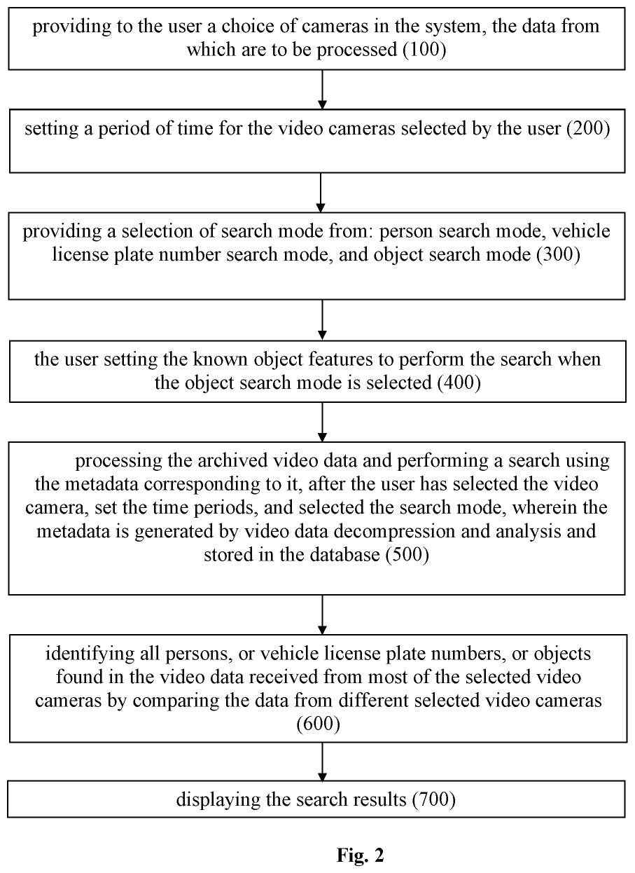

FIG. 2 shows a block diagram of one of the embodiments of the method for processing data from the archive. This method is performed by a computer system that includes at least one data processing device, a database, and memory that stores the archive of video data received from all video cameras in the system. The method contains the stages at which the following operations are executed:

(100) providing the user with a choice of cameras in the system, the data from which will be processed;

(200) setting a period of time for the video cameras selected by the user;

(300) providing the user with a choice of search modes: face search mode, vehicle license plate number search mode, and object search mode;

(400) setting the known object features by the user to perform the search when the object search mode is selected;

(500) processing the archived video data and performing a search using the metadata corresponding to it, after the user has selected the video camera, set the time periods, and selected the search mode, wherein the metadata for all objects in the video are generated by the video data decompression and analysis and stored in the database;

(600) identifying all faces, or vehicle license plate numbers, or objects found in the video data obtained from the largest number of the selected cameras by comparing the data from different cameras; and

(700) displaying the search results.

This method is implemented using the previously described computer system for processing the data from the archive and, therefore, can be expanded and refined by all embodiments that have been described above for implementation of the system for processing the data from the archive.

Stages (100)-(400) are performed by the user using specialized GUI units. The data entered by the user are further used by at least one data processing device to automatically perform subsequent stages (500)-(700) and obtain the required search results.

The embodiments can be implemented using software, hardware, software logic, or their combination. In one example embodiment, software logic, software, or a set of instructions are stored on one or multiple various non-transitory conventional computer-readable data carriers.

In the context of this description, a “computer-readable data carrier” may be any environment or medium that can contain, store, transmit, distribute, or transport the instructions (commands) for their application (execution) by a computer device, such as a personal computer. The data carrier may be an energy-dependent or energy-independent machine-readable data carrier.

If necessary, at least some part of the various operations presented in the description of this solution can be performed in an order differing from the described and/or simultaneously with each other.

Although the technical solution has been described in detail to illustrate the most currently required and preferred embodiments, it should be understood that the invention is not limited to the embodiments disclosed and, moreover, is intended to modify and combine various other features of the embodiments described. For example, it should be understood that this invention implies that, to the possible extent, one or more features of any embodiment may be combined with one or more other features of any other embodiment.

1. A system for processing the data from the archive comprising:
at least two video cameras;
memory made with the ability to store video data archive coming from all video cameras of the system;
database for storing the metadata;
a graphical user interface (GUI) containing at least the following:
a video camera selection unit enabling the user to select specific cameras, the data will from which be processed,
a time period setting unit enabling the user to set a specific video time period for the selected video camera,
search mode selection unit enabling the user selecting one of three possible search modes: face search mode, vehicle license plate number search mode, or object search mode,
search features unit configured for setting the known features of the object to perform search by objects, and
display configured to display the obtained search results;
at least one data processing device configured to perform the following stages:
decompression and analysis of video data to generate metadata that characterizes data on all objects in the video, wherein the mentioned metadata is recorded in the system database;
archived video data processing and search by their respective metadata, after the user has selected the video cameras, set the time periods, and selected the search mode, to identify all persons or vehicle license plate numbers or objects found in the video data received from most of selected video cameras by comparing the data from different selected video cameras;
display of the search result in the display.

2. The system according to claim 1, wherein the metadata generation stage is performed either during the system operation, when video data is received in real time from video surveillance cameras, or immediately before the search, after the user has selected the video cameras, set the time periods, and selected the search mode.

3. The system according to claim 2, wherein the face search mode, all faces recognized in the video data from different selected video cameras are compared to identify all cases when the same face was recognized in the video data from the largest number of the selected video cameras.

4. The system according to claim 2, wherein the vehicle license plate number search mode, all vehicle license plate numbers recognized in the video data from different selected video cameras are compared to identify all cases when the same vehicle license plate number has been recognized in the video data from the largest number of the video cameras selected.

5. The system according to claim 2, wherein the following operations are performed in the object search mode:
search for all objects meeting the set object features; and
comparison of all detected objects from different selected cameras to find the same objects found in video data received from the largest number of selected cameras.

6. The system according to claim 5, wherein the object features include: object type, object color, minimum object size, maximum object size.

7. The system according to claim 6, wherein the object types include: a person, a group of people, a vehicle, or an abandoned object.

8. The system according to claim 1, wherein the time period setting unit is configured to enable the user to set the video time period for each selected camera.

9. The system according to claim 1, wherein the GUI additionally contains a minimum camera share setting unit enabling the user to set the share of selected cameras, in the video data from which the searched face or vehicle license plate number or object must be present in order to be included to the search results.

10. The system according to claim 1, wherein the camera selection unit is additionally configured to enable the user to set, for each selected video camera, the minimum number of appearances of the searched face or vehicle license plate number or object in the camera view area.

11. The system according to claim 1, wherein the GUI additionally contains the unit for building the logic chains, enabling the user to set the video cameras sequence corresponding to a supposed motion path of the searched person or a vehicle or an object.

12. The system according to claim 5, wherein the at comparison of all detected objects, each object found in the video data from the first video camera is compared with each object from each subsequent chosen video camera.

13. The system according to claim 5, wherein the objects detected are compared by the visual similarity calculated using a neural network.

14. The system according to claim 1, wherein the GUI additionally contains a similarity percentage setting unit enabling the user to set a minimum percentage of similarity of the faces when comparing the faces in the face search mode and a minimum percentage of similarity of vehicle license plate numbers when comparing them in the vehicle license plate number search mode,
wherein, if the resulting similarity percentage exceeds the set minimum percentage, the system will consider that the faces or vehicle license plate numbers are similar to a sufficient degree and show them in the search results, while if this percentage is lower—they will be filtered out.

15. The system according to claim 1, wherein the search result is further compared with the database to identify the person or owner of the found vehicle.

16. The system according to claim 1, wherein the search result is displayed as a list or a set of frames.

17. A method for processing the data from the archive implemented by a computer system comprising at least one data processing device, database, and memory storing a video data archive received from all video cameras of the system, wherein the method contains the stages at which the following operations are performed:
providing the user with a choice of specific cameras in the system, the data from which will be processed;
setting a specific period of time for the video cameras selected by the user;
providing the user with a choice of search modes: face search mode, vehicle license plate number search mode, and object search mode;
setting the known object features by the user to perform the search when the object search mode is selected;
archived video data processing and search by their respective metadata, after the user has selected the video cameras, set the time periods, and selected the search mode,
wherein metadata characterizing the data on all objects in the video are generated by decompression and analysis of video data and stored in the system database;
identifying all persons or vehicle license plate numbers or objects found in the video data received from most of selected video cameras by comparing the data from different selected video cameras;
displaying the search result.

18. The method according to claim 1, wherein the metadata generation stage is performed either during the system operation, when video data is received in real time from video surveillance cameras, or immediately before the search, after the user has selected the video cameras, set the time periods, and selected the search mode.

19. The method according to claim 18, wherein the face search mode, all faces recognized in the video data from different selected video cameras are compared to identify all cases when the same face was recognized in the video data from the largest number of the selected video cameras.

20. The method according to claim 18, wherein the vehicle license plate number search mode, all vehicle license plate numbers recognized in the video data from different selected video cameras are compared to identify all cases when the same vehicle license plate number has been recognized in the video data from the largest number of the video cameras selected.

21. The method according to claim 18, wherein the following operations are performed in the object search mode:
search for all objects meeting the set object features; and
comparison of all detected objects from different selected cameras to find the same objects found in video data received from the largest number of selected cameras.

22. The method according to claim 21, in which the object features include: object type, object color, minimum object size, maximum object size.

23. The method according to claim 22, wherein the object types include: a person, a group of people, a vehicle, or an abandoned object.

24. The method according to claim 17, wherein the user to set own video time period for each selected video camera.

25. The method according to claim 17, wherein the user to set the share of selected cameras, in the video data from which the searched face or vehicle license plate number or object must be present in order to be included to the search results.

26. The method according to claim 17, wherein the user to set, for each selected video camera, the minimum number of appearances of the searched face or vehicle license plate number or object in the camera view area.

27. The method according to claim 17, wherein the user to set the video cameras sequence corresponding to a supposed motion path of the searched person or a vehicle or an object.

28. The method according to claim 21, wherein the at comparison of all detected objects, each object found in the video data from the first video camera is compared with each object from each subsequent chosen video camera.

29. The method according to claim 21, wherein the objects detected are compared by the visual similarity calculated using a neural network.

30. The method according to claim 17, wherein the user to set the minimum percentage of similarity of faces when comparing them in the face search mode and the minimum percentage of similarity of vehicle numbers when comparing them in the license plate number search mode;
wherein, if the resulting similarity percentage exceeds the set minimum percentage, the system will consider that the faces or vehicle license plate numbers are similar to a sufficient degree and show them in the search results, while if this percentage is lower—they will be filtered out.

31. The method according to claim 17, wherein the search result is further compared with the database to identify the person or owner of the found vehicle.

32. The method according to claim 17, wherein the search result is displayed as a list or a set of frames.

33. A computer-readable data carrier containing instructions executed by the computer processor for executing the methods of archive data processing according to claim 17.
